(19) United States
(12) Patent Application Publication
(10) Pub. No.: US 2017/0362882 A1
(43) Pub. Date: Dec. 21, 2017

(54) INSULATING WINDOW UNIT

(71) Applicant: AGC GLASS EUROPE, Louvain-La-Neuve (BE)

(72) Inventors: Nicolas BOUCHER, Ecaussinnes-d'Enghien (BE); Oliver BOUESNARD, Ittre (BE); Francois CLOSSET, Jalhay (BE); Pierre SCHNEIDER, Romagne (FR)

(73) Assignee: AGC GLASS EUROPE, Louvain-La-Neuve (BE)

(21) Appl. No.: 15/534,563

(22) PCT Filed: Dec. 9, 2015
(86) PCT No.: PCT/EP2015/079127

§ 371 Date: Jun. 9, 2017

(30) Foreign Application Priority Data
Dec. 12, 2014 (EP) 14197688.6

(51) Int. Cl. E06B 3/663; E06B 3/67; E06B 3/673

(52) U.S. Cl. CPC E06B 3/66333; E06B 3/67326; E06B 3/66352; E06B 3/6715; E06B 2003/66338

(57) ABSTRACT

An insulating window unit for a building including adjacent glazed panels linked to each other by at least one translucent connection element having a structural function, wherein each glazed panel is a multiple glazing unit including plural sheets of glass enclosing at least one closed space between the sheets and including at least one translucent seal along a connection edge of same facing the other adjacent glazed panel.

### 1. FIELD OF THE INVENTION

The present invention relates to an insulating glass wall for a building, in particular the insulating glass walls that equip showrooms, halls of public and commercial buildings, verandas and pergolas. Nevertheless, any other application that requires such large-sized glass walls having properties of efficient thermal insulation and sufficient resistance to the wind and other atmospheric conditions also falls within the scope of invention.

### 2. PRIOR ART

Large glass walls that equip showrooms and halls of public and commercial buildings are already known. In certain cases, such as for example in the case of car dealership showrooms, these glass walls are generally formed by the juxtaposition of large glass sheets separated by connection elements that are more or less visible, and they may occupy up to the entire area of one or even several of the walls of a building. Such glass walls enable good visibility of the cars displayed. However, in countries where the winters are cold, this poses the difficult problem of the significant heat loss linked to the high overall thermal conduction properties of large areas of glass.

Thus, several solutions have been envisaged in order to improve the thermal insulation performance of these large glass walls, including the assembly of multiple glazing panels. Thus, document WO 2010/119067 A1 discloses a multiple wall glazing unit comprising at least two transparent spacer bars made of tempered glass which are fixed to the glass panels by means of transparent or translucent sealing materials. Besides the passage of light via the sides of the glazing, such a glazing unit ensures resistance to the forces resulting from variations of the external atmospheric pressure. Document WO 201o/119067 A1 does not address the problem of limiting the heat losses of a glass wall which would obscure the vision of the articles positioned inside the building as little as possible.

These poor insulation properties remain a problem despite the possible use of glass coated with metal and/or metal oxide layers that limit the emission of radiation from the surface of the glass, in particular in the near infrared wavelength range.

### 3. OBJECTIVES OF THE INVENTION

The objective of the invention is to overcome the drawbacks of known glass walls by providing a novel glass wall which:
limits the heat losses of the building,
obscures the vision of the articles positioned inside the building as little as possible,
and ensures a stiffness of the surface and more generally a sufficient resistance to the wind and other atmospheric conditions.

### 4. SUMMARY OF THE INVENTION

For this purpose, the invention relates to an insulating glass wall for a building comprising at least two glazed panels, according to which:
a. in each pair of adjacent glazed panels, the panels are connected to one another by at least one translucent connection element having a structuring function;
b. each glazed panel is a multiple glazing comprising several glass sheets containing at least one space between the sheets and comprising at least one translucent sealing joint along its connecting edge facing the other adjacent glazed panel.

A glass wall is understood to denote a glazed area occupying the whole of an opening made in a wall or a roof of a building. Such a glass wall does not have an opening to the atmosphere outside of the building and consists of several glazed panels joined to one another. Said glass wall is of fixed, non-opening nature.

### 5. LIST OF FIGURES

The present invention will be better understood on reading the detailed description below of nonlimiting exemplary embodiments and from the appended figures.

FIGS. 1 to 7 below illustrate the invention. More specifically:

FIG. 1: illustrates the spacer frame (1) formed by the horizontal (3) and vertical (2) spacers and the attachment means (4) and (5) according to examples 1 and 2.

FIG. 2: illustrates a cross section of the vertical spacer (2) of the spacer frame according to example 1. The following elements are represented: the glass sheets (11), the first translucent vertical individual joint (6), the second translucent vertical individual joint (7), the vertical spacer made of translucent organic resin (2).

FIG. 2a: illustrates a cross section of the vertical spacer (2) of the spacer frame according to example 2. In this variant, one of the two glass sheets (11) is offset with respect to the other.

FIG. 3: illustrates a cross section of the horizontal spacer (3), a component of the spacer frame according to examples 1 and 2. The following elements are represented: the glass sheets (11) and (11a), the first horizontal individual joint (8), the second horizontal individual joint (9), the horizontal spacer (3).

FIG. 4: illustrates a cross section of the insulating glass wall according to example 1. The following elements are represented: the glazed panels (12), the glass sheets (11), the vertical spacers made of translucent organic resin (2), the translucent vertical individual joints (6) and (7), the translucent connection element having a structuring function (7a).

FIG. 5: illustrates a cross section of the insulating glass wall with the connection element (7a) reinforced by a wind brace (10) according to example 2. The elements represented are: the glazed panels (12), the glass sheets (11) and (11a), the vertical spacers made of translucent organic resin (2), the translucent vertical individual joints (6) and (7), the translucent connection element having a structuring function (7a), the wind brace system (10).

FIG. 6: illustrates a cross section in the insulating glass wall with the connection element (7a). This view represents the following elements: the glazed panels (12), the glass sheets (11), the laminated glasses (14), the vertical spacers made of translucent organic resin (2), the translucent vertical individual joints (6) and (7), and the translucent connection elements having a structuring function (7a) and (7b).

FIG. 7: illustrates a cross section in the insulating glass wall with the connection element (7a) reinforced by a laminated glass beam (16). This view represents the following elements: the glazed panels (12) forming the glass wall, the glass sheets (11), the vertical spacers made of translucent organic resin (2), the translucent vertical individual joints (6) and (7), the translucent connection element having a structuring function (7a), the glass beam comprising a laminated glass (16).

### 6. DETAILED DESCRIPTION OF THE INVENTION

An insulating glass wall denotes a glass wall that limits heat exchanges with the atmosphere outside of the building substantially more than a current conventional glass wall provided with single glazings would do.

In order to illustrate the ideas, a glazed panel forming a glass wall according to the invention has a thermal insulation value Ug ranging from 0.3 to 1.8, preferably from 0.6 to 1.4 and most preferably from 1.0 to 1.4 W/m². The thermal insulation value Ug corresponds the amount of heat that the glazed panel forming the glass wall according to the invention lets through.

The glass wall in accordance with the invention comprises at least two glazed panels, i.e. two elements made of glass, having a flat or curved surface, which are assembled in order to form the glass wall. Flat panel surfaces are preferred. Often, the glass wall comprises more than two panels positioned side-by-side over one or more rows. The shape of these panels is usually square or rectangular, but may also take any other shape comprising any number of straight and/or curved edges.

According to the invention, each glazed panel is a multiple glazing that comprises several glass sheets. These glass sheets have a thickness ranging from 0.5 mm to 15 mm (for example 4 or 8 mm thick soda-lime-silica glass sheets) joined by means of a spacer frame that holds them at a certain distance from one another. Usually, the glass wall in accordance with the invention comprises at least one double or triple glazing. Each panel contains at least one closed space between the glass sheets. According to the invention, the glass sheets may be of different sizes.

According to the invention, each glazed panel also comprises at least one translucent sealing joint. This sealing joint is positioned at least along the edge of the panel which is connected with an adjacent glazed panel. Preferably, each glazed panel comprises a composite sealing joint consisting of several individual joints positioned in the periphery of spacer(s) so as to simultaneously optimize the stiffness of the panel and the gas tightness and moisture tightness thereof. Usually, each glazed panel comprises two individual joints: the purpose of the first, the tie joint, being to rigidly tie the spacer to the two glass sheets and the purpose of the second, the sealing joint, being to perfect the gas tightness and moisture tightness.

According to one embodiment of the glass wall according to the invention, all the sealing joints of each multiple glazing panel are translucent.

Examples of materials used for these sealing joints are:
for the tie joint: a translucent mastic of translucent silicone, translucent modified silicone (MS-Polymer) or translucent polyurethane (PU) type, a translucent hybrid mastic comprising silicone and polyurethane, a translucent adhesive of translucent acrylic or epoxy type, a translucent organic tie sheet for tying to the glass of polyvinyl butyral (PVB), polyurethane (TPU), ethylene/vinyl acetate copolymer (EVA) or ionomer type or a combination of two or more of these compounds.
for the sealing joint: a translucent mastic of translucent butyl and polyisobutylene type, a translucent synthetic rubber-based mastic, a translucent adhesive of translucent acrylic or epoxy type, a translucent organic film based on polyester or polyurethane resin covered with at least one translucent metal or metal oxide layer, and a translucent organic tie sheet for tying to the glass of polyvinyl butyral (PVB), polyurethane (TPU), ethylene/vinyl acetate copolymer (EVA) or ionomer type or a combination of two or more of these compounds.

In order to illustrate the ideas, the gas tightness is measured according to the method described in the EN1279-3 standard. Thus, the gas leakage from a glazed panel forming an insulating glass wall according to the invention does not exceed 3%/year and, preferably, does not exceed 1%/year.

The moisture tightness is itself characterized by the measurement of the index I according to the EN1279-2 standard. The index I of a glazed panel forming an insulating glass wall according to the invention must be less than or equal to 25% and, preferably, less than or equal to 20%.

Furthermore, in order to be suitable as a panel in a glass wall according to the invention, it is necessary that their spacer(s) located in the vicinity of the edges of these panels intended to be brought together and assembled in the glass wall is (are) also translucent.

The term “translucent” encompasses both elements that are completely transparent and those which let through at least 1% of incident light, without however clearly transmitting the image of the objects located on the other side thereof. The term “non-translucent” refers to elements that let through less than 1% of incident light and that do not clearly transmit the image of the objects located on the other side thereof. According to the invention, in each pair of adjacent glazed panels, the panels are connected to one another by at least one translucent connection element having a structuring function. The translucent connection element denotes any translucent part or joint, the function of which is to structurally connect, i.e. by providing a sufficient resistance to the wind and other atmospheric conditions, two adjacent glazed panels while creating as small as possible an obstacle to the passage of light. Sufficient resistance means here maintaining the connection between the panels until a maximum deformation of the panels which corresponds to the failure of at least one glass sheet of a panel, in such a way that the structure of the glass wall is preserved. The other atmospheric conditions are, for example, UV radiation, snow, rain, humidity, temperature.

According to a first embodiment, the connection element of the glass wall is a structuring joining means selected from a translucent mastic such as translucent silicone, translucent modified silicone (MS-Polymer), translucent polyurethane (PU), translucent hybrid mastic comprising silicone and polyurethane, a translucent adhesive of translucent acrylic or epoxy type, a translucent organic sheet of polyvinyl butyral (PVB), polyurethane (TPU), ethylene/vinyl acetate copolymer (EVA) or ionomer type or a combination of two or more of these compounds. Preferably, the structuring joining means is selected from translucent silicone, MS-Polymer, PU, translucent hybrid mastic comprising silicone and polyurethane, a translucent adhesive of translucent acrylic or epoxy type or a combination of two or more of these compounds. More preferably still, the structuring joining means is selected from a translucent adhesive of acrylic type or a translucent silicone or the combination of these two compounds.

According to a second embodiment, the translucent connection element having a structuring function is a beam consisting of a profile of elongated shape made from a material selected from rigid and flexible translucent materials or a combination of these two materials. Examples of materials that may be suitable for the production of a beam in accordance with the invention are: glass and a translucent organic resin comprising polymethyl methacrylate (PMMA), polycarbonate (PC), polystyrene (PS), polyvinyl chloride (PVC), an acrylonitrile-butadiene-styrene copolymer (ABS), a polyamide such as nylon or a combination of at least two of these resins. Other examples of such materials are a polyetherimide (PEI), a styrene-acrylonitrile copolymer (SAN), polyesters such as polyethylene terephthalate (PET), polybutylene terephthalate (PBT), or a combination of at least two from the set of the aforementioned resins. Preferably, materials that may be suitable for the production of a beam in accordance with the invention are PMMA, PC and PET. More preferably still, the materials that may be suitable for the production of a beam in accordance with the invention are PMMA and PC due to their high transparency and their ease of use.

In the case of a glass beam, it is possible to use a laminated glass comprising at least one translucent organic tie sheet for tying to the glass. An example of such an organic sheet which is highly suitable is a sheet made of polyvinyl butyral (PVB).

According to this second embodiment, each panel may advantageously be structurally connected to the beam by means of translucent connection means. These connection means are selected, in accordance with the invention, from a translucent mastic such as translucent silicone, translucent modified silicone (MS-Polymer), translucent polyurethane (PU), translucent hybrid mastic comprising silicone and polyurethane, a translucent adhesive of translucent acrylic or epoxy type, a translucent organic sheet of polyvinyl butyral (PVB), polyurethane (TPU), ethylene/vinyl acetate copolymer (EVA) or ionomer type or a combination of two or more of these compounds. Preferably, the translucent connection means are selected from translucent silicone, translucent modified silicone (MS-Polymer), translucent polyurethane (PU), translucent hybrid mastic comprising silicone and polyurethane, a translucent adhesive of translucent acrylic or epoxy type or a combination of two or more of these compounds. More preferably still, the connection means are selected from a translucent adhesive of acrylic type or a translucent silicone or the combination of these two compounds.

According to the two embodiments of the glass wall in accordance with the invention, at least one translucent connection element having a structuring function is reinforced by a translucent wind brace connected to this connection element, the wind brace being located on a side of the glass wall which is a side inside the building. The translucent wind brace may consist of at least one optionally laminated glass part or of at least one rigid plastic part positioned perpendicular to the plane of the surface of the panels, or else of an assembly of at least one glass part with at least one plastic part. Preferably, the wind brace is connected to the translucent connection element connecting two glazed panels by means of the same connection means as those which are suitable for connecting the beam structurally to the glazed panels mentioned above.

The glass wall in accordance with the invention comprises at least one glazed panel which comprises at least one closed space between a pair of adjacent glass sheets which is filled with a dry gas. Preferably, all the glazed panels of the glass wall comprise at least one closed space filled with a dry gas. More preferably still, each closed space of each panel is filled with a dry gas. If the glazed panels are triple glazings, for example, they each comprise two closed spaces which are both filled with a dry gas. The dry gases that are particularly suitable are selected from air, nitrogen, argon, xenon, krypton and a mixture of at least two of these gases. The same dry gas may fill all the closed spaces of one particular panel. The same dry gas may also fill all the closed spaces of all the panels. Alternatively, it is possible to use different dry gases to fill the various closed spaces of one and the same panel/of all the panels.

Usually, in an insulating glass wall in accordance with the invention, the glazed panels are flat and parallel to a vertical plane and the connection element for connecting these panels with the adjacent panels is also vertical. In certain cases, the panels may be inclined in the glass wall which then acts as a roof. The maximum inclination corresponds to a position parallel to a horizontal plane. In these latter cases, the connection element forms a certain angle with a vertical line that passes through a point located at the upper end of the connection element. This angle remains less than 90° for inclined panels and reaches 90° in the case of a horizontal panel.

According to the invention, each glazed panel is a multiple glazing comprising at least a first glass sheet and a second glass sheet joined together by means of a spacer frame which holds them at a certain distance from one another.

A spacer frame denotes a rigid element, positioned between the glass sheets in the vicinity of the periphery thereof and which holds them at a certain distance from one another.

The spacer frame comprises at least one vertical spacer made of translucent organic resin and at least two horizontal spacers each composed of a profile comprising at least one attachment piece, said spacers being connected together in order to form said frame.

According to one preferred embodiment, the horizontal spacers are each composed of a profile made of non-translucent material and comprising at least one attachment piece.

An attachment piece should be understood to mean, in a known manner, a piece that enables the attachment of a first element to at least one second element. Said attachment piece being, for example, a pressure, a glue, a pin, a screw of steel, galvanized steel, stainless steel or bronze type, or any other means that ensures the connection between said elements to be assembled. Another example of an attachment piece is a butyl pellet optionally combined with a screw.

This is understood to mean that the attachment piece is a piece that enables the attachment of at least one vertical spacer to at least one horizontal spacer.

A second function of the attachment piece is to guarantee the moisture tightness and gas tightness of each glazed panel.

The adjectives vertical and horizontal are understood to denote placements close to opposite edges, i.e. non-contiguous edges of the frame and/or of the glazing and that are facing each other.

An example of a suitable spacer frame is described in detail in the patent applications in the name of AGC Glass Europe bearing the filing numbers PCT/EP2014/061128, EP 14 158 278.3 and EP 14 188 477.5 that are incorporated here by reference.

According to a first particular embodiment, a first translucent individual joint of acrylic, butyl or silicone type is deposited at each translucent spacer/glass sheet interface. A second individual joint of butyl, acrylic or silicone type and of a different nature to the first individual joint is deposited adjacent to the first joint and at each translucent spacer/glass sheet interface. This option makes it possible to guarantee the gas tightness and moisture tightness of the glazed panel by concentrating the joints over one and the same interface, and to guarantee a maximum light transmission of the translucent spacer over the vertical edges of the glazed panel. This embodiment makes it possible to connect glazed panels comprising offset glass sheets, the edge-to-edge assembly of which in a glass wall according to the invention is carried out via each offset glass of the panels.

Preferably, in this first embodiment, the vertical edges of the glazed panels forming the glass wall according to the invention are joined by a translucent connection element of silicone, modified silicone or polyurethane type. The vertical edges of two contiguous glazed panels of the glass wall are denoted here. This connection element also acts as an additional sealing joint for the glazed panel.

According to a second particular embodiment, a first translucent individual joint of acrylic, butyl or silicone type is deposited at each translucent spacer/glass sheet interface. A translucent film of polyester or polyurethane type covered by a translucent metallic layer is applied to the edge of the translucent spacer so as to also cover the outer edges of the first individual joint and act as a second individual joint. A translucent metallic layer is understood to denote a translucent layer composed of at least one metallic material which may be a pure metal, an alloy of pure metals or a metallic material such as a metal oxide or metal sulphide. This particular solution additionally guarantees maximum translucency over the edges of each glazed panel of the glass wall.

The vertical edges of the glazed panels forming the glass wall according to this second particular embodiment are joined by a translucent connection element of silicone, modified silicone or polyurethane type. The vertical edges of two contiguous glazed panels of the glass wall are also denoted here. Preferably, this connection element also acts as an additional sealing joint for the glazed panel.

According to a third particular embodiment, a first translucent individual joint of PVB, polyurethane (TPU), EVA or ionomer type that may require a curing cycle in a controlled atmosphere, is deposited at each translucent spacer/glass sheet interface. In order to increase the tightness of the glazing, a translucent film of polyester or polyurethane type covered by a translucent metallic layer may be applied to the edge of the translucent spacer also covering the outer edges of the first individual joint and acting as a second individual joint. The metallic layer has the same meaning as in the second embodiment. This particular solution additionally guarantees maximum translucency over the edges of each glazed panel of the glass wall.

In this third embodiment also, when two glazed panels are adhesively bonded edge-to-edge, the vertical edges of the glazed panels forming the glass wall are joined by a translucent connection element of silicone, modified silicone or polyurethane type. The vertical edges of two contiguous glazed panels of the glass wall are also denoted here. Preferably, this connection element also acts as an additional sealing joint for the glazed panel.

According to a fourth particular embodiment, a first translucent individual joint of acrylic, butyl or silicone type is deposited at each translucent spacer/glass sheet interface. A second individual joint of butyl, acrylic or silicone type and of a different nature to the first individual joint is deposited on the edge of the translucent spacer so as to also cover the outer edges of the first individual joint. Like the preceding embodiments, this embodiment makes it possible to connect glazed panels comprising offset glass sheets, the edge-to-edge assembly of which in a glass wall according to the invention is carried out via each offset glass of the panels.

Preferably, in this embodiment, the vertical edges of the glazed panels forming the glass wall according to the invention are joined by a translucent connection element of silicone, modified silicone or polyurethane type. The vertical edges of two contiguous glazed panels of the glass wall are denoted here. This connection element also acts as an additional sealing joint for the glazed panel.

According to another embodiment of the glass wall according to the invention, at least one glass sheet of each glazed panel is coated with a layer of metal or metal oxide that makes it possible to improve the thermal insulation and/or solar control performance of the glazed panel. For example, a low-emissivity layer may be found therein, deposited by any suitable technique that is itself well-known.

Another option is also to replace at least one glass sheet of at least one glazed panel with a laminated structure having a safety or acoustic function comprising at least one sheet made of translucent organic material such as polyvinyl butyral (PVB) adhesively bonded on both sides thereof to a glass sheet. Such stacks have total glass thicknesses (not including the thickness of the sheet(s) made of translucent organic material) ranging from 4 mm up to and including 24 mm.

Another embodiment of the glass wall according to the invention consists in using a tempered glass for at least one glass sheet of at least one glazed panel.

Yet another option consists in using, for at least one glass sheet of at least one glazed panel, a glass with a low iron content comprising an amount of iron, expressed as Fe₂O₃, ranging from 0.002 to 0.01% of the total weight of the glass.

Another embodiment of the glass wall according to the invention consists in using an enamelled, screenprinted or matt glass for at least one glass sheet of at least one glazed panel.

The invention also relates to a process for manufacturing an insulating glass wall for a building according to the invention, according to which at least two glazed panels are hermetically assembled at one of their edges at least with the aid of a translucent connection element having a structuring function.

### 7. EXAMPLES

### Example 1

### In Accordance with the Invention

An insulating glass wall was assembled according to the following procedure.

Two insulating glazed panels (12) in the form of double glazings (FIGS. 1 to 4) were selected in order to form a glass wall. They consisted of two soda-lime-silica float glass sheets (11) ground at their edges, having a thickness of 8 mm and dimensions of 3000 mm×2000 mm and of a spacer frame (1) made of PMMA which comprises two translucent vertical spacers (2) (2000 mm long) and two non-transparent horizontal spacers (3) of “warm edge” type (2970 mm long). The spacer frame (1) is illustrated in FIG. 1.

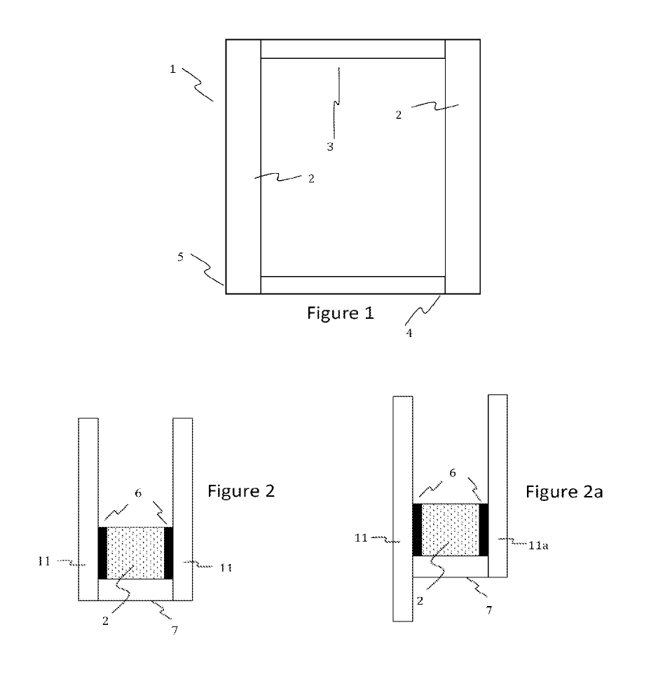

Each translucent PMMA spacer (2) has a thickness (corresponding to the distance between two glass sheets) of 12 mm and a height of 10 mm. At each end, a 6.0 mm diameter hole was drilled in the translucent vertical spacer (2) in the direction normal to its thickness and at a distance equidistant from each lateral edge and then firmly attached to the horizontal spacer (3) with the aid of a screw (5). A bead (6) comprising Oppanol® polyisobutylene (product from the company BASF), having a weight of 4 g/m, was deposited at each translucent vertical spacer (2)/glass sheet (11) interface (FIG. 2).

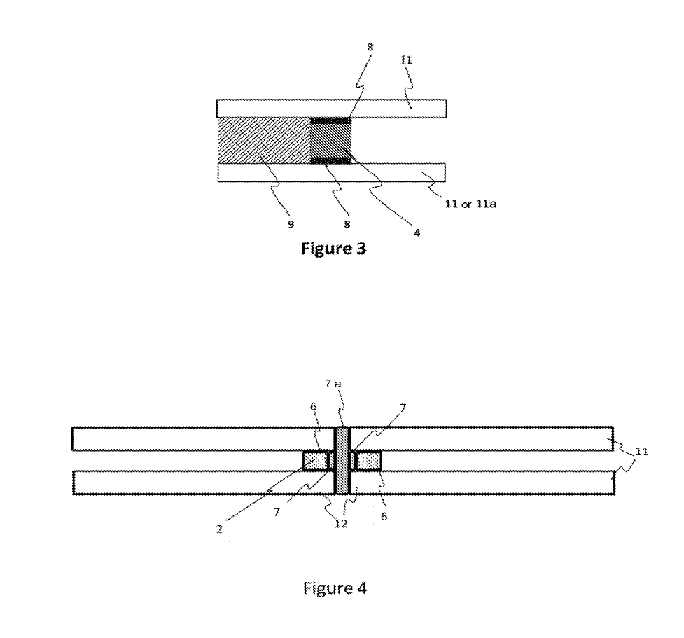

Each horizontal spacer (3) is composed of a “warm-edge” closed profile made of polypropylene/stainless steel comprising two attachment pieces (4) (see FIG. 3). The spacer (3) is hollow and has, as dimensions, a length of 2970 mm and a thickness of 15 mm. The spacer (3) is filled with desiccant and the sides are adhesively bonded to the two glass sheets (11) by means of the butyl (8). The vertical (2) and horizontal (3) spacers are attached by four screws (5) (FIG. 1). Each screw is inserted into each attachment piece via the holes drilled in the translucent spacers (2).

The spacer frame (1) was pressed against one of the glass sheets (11). The second glass sheet (11) was deposited on the other side of the frame and pressed automatically by a vertical gas-pressing system. During this pressing step, an insulating gas (argon) was inserted into the double glazing in a proportion of at least 85% by volume and 15% dry air. Any bubbling phenomenon at the polyisobutylene (6)/glass sheet (11) interface was carefully avoided (FIG. 2). The horizontal edges of the double glazing were then glued with a Dow Corning DC® 3362 silicone mastic (9) (FIG. 3). This mastic also glued each horizontal spacer (3). The vertical edges of the glazing were glued with a Sikaflex® MS-Polymer translucent mastic (7) from the company Sika. This mastic also glued the translucent PMMA spacer (2).

The two constituent glazed panels (12) of the insulating glass wall were then joined and firmly attached by a Sikaflex® translucent MS (“modified silicone”) Polymer mastic (7a) from the company Sika.

### Example 2

### In Accordance with the Invention

An insulating glass wall was assembled according to the following procedure.

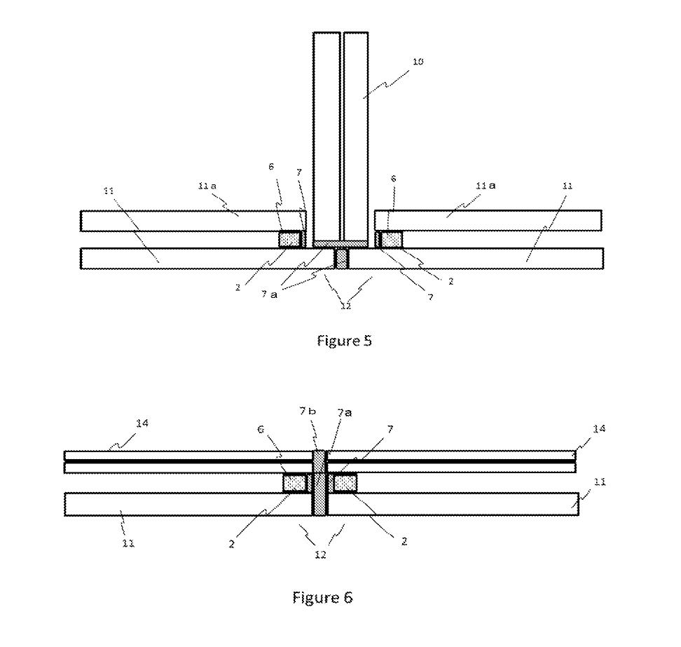

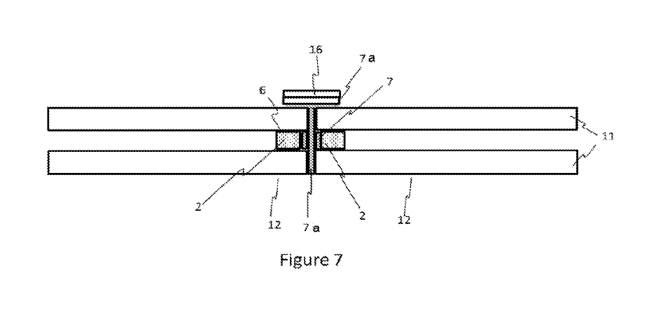

Two insulating glazed panels (12) in the form of double glazings (FIG. 5) were selected in order to form a glass wall. They each consisted of two soda-lime-silica float glass sheets (11) and (11a) ground at their edges, having a thickness of 8 mm and dimensions of 3000 mm×2000 mm for the glass sheet (11) and 2900 mm×2000 mm for the glass sheet (11a) and of a spacer frame (1) made of PMMA which comprises two translucent vertical spacers (2) (2000 mm long) and two non-transparent horizontal spacers (3) of “warm edge” type (2970 mm long).

Each translucent PMMA spacer (2) has a thickness (corresponding to the distance between two glass sheets) of 12 mm and a height of 10 mm. At each end, a 6.0 mm diameter hole was drilled in the translucent vertical spacer (2) in the direction normal to its thickness and at a distance equidistant from each lateral edge in order to be able to firmly attach this translucent vertical spacer (2) to the horizontal spacer (3) with the aid of a screw (5). A bead (6) comprising Oppanol® polyisobutylene (product from the company BASF), having a weight of 4 g/m, was deposited at each transparent spacer (2)/glass sheet (11), (11a) interface (FIG. 2a).

Each horizontal spacer (3) is composed of a “warm-edge” closed profile made of polypropylene/stainless steel comprising two attachment pieces (4) (FIG. 3). The spacer (3) is hollow and has, as dimensions, a length of 2970 mm and a thickness of 15 mm. The spacer (3) is filled with desiccant and the sides are adhesively bonded to the two glass sheets (11), (11a) by means of the butyl (8). The vertical (2) and horizontal (3) spacers are attached by four screws (5) (FIG. 1). Each screw is inserted into each attachment piece via the holes drilled in the translucent spacers (2).

The spacer frame was pressed against the glass sheet (11a). The glass sheet (11) was then deposited on the other side of the frame (in such a way that the frame is placed at a distance equidistant from each vertical edge of the glass (11)) and was pressed automatically by a vertical gas-pressing system. During this pressing step, an insulating gas, of argon type, was inserted into the double glazing in a proportion of at least 85% by volume and 15% dry air. Any bubbling phenomenon at the polyisobutylene (6)/glass sheet (11) and (11a) interface was carefully avoided. The horizontal edges of the glazed panel were then glued with Dow Corning DC® 3362 silicone mastic (9). This mastic also glued each horizontal spacer. The vertical edges of the double glazing were then glued with Sikaflex® MS-Polymer translucent mastic (7) from the company Sika, which also glued the translucent PMMA spacer (2).

The two glazed panels (12) forming the insulating glass wall were then joined and firmly attached by a translucent modified silicone (MS-Polymer) mastic (7a) (of Sikaflex® type from the company Sika) which also glued the edges of the glass sheets (11) of each glazed panel. A wind brace (10) was also joined to this attachment by also glueing the latter in the translucent mastic (7a) (FIG. 5).

### Example 3

### In Accordance with the Invention

An insulating glass wall was assembled according to the following procedure.

Two insulating glazed panels (12) in the form of double glazings (FIGS. 1 to 3 and 6) were selected in order to form a glass wall. They consisted of a 66.2 laminated glass (14) and a soda-lime-silica float glass (11) ground at its edges, having a thickness of 8 mm, tempered and having dimensions of 1800 mm×1200 mm and of a spacer frame (1) made of PMMA which comprises two translucent vertical spacers (2) (1200 mm long) and two non-transparent horizontal spacers (3) of “warm edge” type (1770 mm long).

Each translucent PMMA spacer (2) has a thickness of 12 mm and a height of 10 mm. The translucent vertical spacer (2) is firmly attached to the horizontal spacer (3) with the aid of a polyisobutylene pellet. An acrylic tape (6) of VHB 4918 type was deposited at each translucent vertical spacer (2)/glass sheet (11), (14) interface.

Each horizontal spacer (3) is composed of a “warm-edge” closed profile made of polypropylene/stainless steel. The spacer (3) is hollow and has, as dimensions, a length of 1770 mm and a thickness of 15 mm. The spacer (3) is filled with desiccant and the sides are adhesively bonded to the two glass sheets (11) by means of the butyl (8) The vertical (2) and horizontal (3) spacers are attached by four polyisobutylene pellets 4.

The spacer frame (1) was pressed against one of the glass sheets (11). The second glass sheet (14) was deposited on the other side of the frame and pressed automatically by a vertical gas-pressing system. During this pressing step, an insulating gas (argon) was inserted into the double glazing in a proportion of at least 85% by volume and 15% dry air. Any bubbling phenomenon at the polyisobutylene (6)/glass sheet (11), (14) interface was carefully avoided. The horizontal edges of the double glazing were then glued with a Dow Corning DC® 3362 silicone mastic (9) (FIG. 3). This mastic also glued each horizontal spacer (3). The vertical edges of the glazing were covered with a polyester strip (7). This tape also covered the edges of the translucent PMMA spacer (2).

The two constituent glazed panels (12) of the insulating glass wall were then joined and firmly attached by a VHB 4918 acrylic tape (7a) and also by a Sikaflex® translucent silicone (7b) from the company Sika (FIG. 6).

### Example 4

### Performance of the 3M VHB 4918 Structuring Acrylic Tape

In order to characterize the adhesion performance of the 3M VHB 4918 structuring acrylic adhesive, a tensile test was carried out according to the method described in the EN 1279-4 standard. This type of structuring acrylic adhesive withstands the atmospheric conditions as demonstrated in the table below:

| | | Type of failure | | | | |
|---|---|---|---|---|---|---|
| | Mean failure (MPa) over | Samples | | | | |
| Test | 5 samples | 1 | 2 | 3 | 4 | 5 |

| | | |
|---|---|---|
| Tensile test on the | 0.39 | 100% cohesive |
| initial sample | | |
| Tensile test after | 0.43 | 100% cohesive |
| exposure to heat | | |
| Tensile test after | 0.32 | 100% cohesive |
| immersion in water | | |
| Tensile test after UV | 0.51 | 100% cohesive |
| exposure | | |

The samples were produced from two rectangular plates of soda-lime-silica float glass having a thickness of 4 mm and dimensions of 65 mm×25 mm. One of the two glasses had been precoated with a TopN+T low-emissivity layer. Firstly, the glass surfaces to be adhesively bonded were cleaned with isopropanol, then a 25×10 mm strip of tape was applied transversely to one of the glass sheets so as to cover the entire width of the sheet in a central position thereof while carefully avoiding the formation and trapping of any air bubble between the tape and the glass sheet. The second glass sheet was then adhesively bonded in its central position to the other side of the tape already adhesively bonded to the first glass sheet so that the glass sheets together form an angle of 90°.

The tensile test carried out on the samples consists in placing the two glass sheets of each sample under tension. The tension is exerted in a direction perpendicular to the surface of each of the 2 glass sheets under an atmosphere of 25° C. and 50% RH. The tensile strength needing to be applied to the glass sheets in order to cause the detachment and complete separation of the two sheets was measured. The test is carried out on the initial samples and also on the samples after exposure to heat, after immersion in water and after UV exposure.

In all cases, the failure was of cohesive type within the material of the tape. The cohesive failure within the tape reflects a good attachment quality. All of these results show that the adhesion performance of the structuring acrylic adhesive meets the requirements of the EN 1279-4 standard and demonstrates its structuring nature.

1-16. (canceled)

17. An insulating glass wall for a building comprising:
at least two glazed panels; wherein:
in each pair of adjacent glazed panels, the panels are connected to one another by at least one translucent connection element having a structuring function;
each glazed panel is a multiple glazing comprising plural glass sheets containing at least one closed space between the sheets and comprising at least one translucent sealing joint along its connecting edge facing the other adjacent glazed panel.

18. An insulating glass wall according to claim 17, wherein each glazed panel is a multiple glazing comprising at least a first glass sheet and a second glass sheet which are joined together by a spacer frame which holds the first and second glass sheets at a certain distance from one another and which comprises at least one vertical spacer made of translucent organic resin and at least two horizontal spacers each of a profile comprising at least one attachment piece, the spacers being connected together to form the frame.

19. An insulating glass wall according to claim 17, wherein in at least one glazed panel, at least one closed space between a pair of adjacent glass sheets is filled with a dry gas selected from air, nitrogen, argon, xenon, krypton, or a mixture of at least two of these gases.

20. An insulating glass wall according to claim 17, wherein the glazed panels joined by at least one translucent connection element have a gas leakage of less than 3% per year measured according to the EN1279-3 standard, and a moisture tightness corresponding to an index I of less than or equal to 25% measured according to the EN1279-2 standard.

21. An insulating glass wall according to claim 17, wherein the translucent connection element includes a structuring joining means selected from a translucent mastic or translucent silicone, translucent modified silicone (MS-Polymer), translucent polyurethane (PU), a translucent hybrid mastic comprising silicone and polyurethane, a translucent adhesive of translucent acrylic or epoxy type, a translucent organic sheet of polyvinyl butyral (PVB), polyurethane (TPU), ethylene/vinyl acetate copolymer (EVA) or ionomer type, or a combination of two or more of these compounds.

22. An insulating glass wall according to claim 17, wherein the translucent connection element includes a beam with a profile of elongated shape made from a material selected from rigid and flexible translucent materials or a combination of these two materials.

23. An insulating glass wall according to claim 22, wherein the beam is a glass beam that comprises a laminated glass comprising at least one organic translucent sheet.

24. An insulating glass wall according to claim 22, wherein each glazed panel is structurally connected to the beam by translucent connection means selected from a translucent mastic or translucent silicone, translucent modified silicone (MS-Polymer), translucent polyurethane (PU) and translucent hybrid mastic comprising silicone and polyurethane, a translucent adhesive of translucent acrylic or epoxy type, a translucent organic sheet of polyvinyl butyral (PVB), polyurethane (TPU), ethylene/vinyl acetate copolymer (EVA) or ionomer type, or a combination of two or more of these compounds.

25. An insulating glass wall according to claim 17, wherein at least one translucent connection element is reinforced by a translucent wind brace connected to the connection element, the wind brace being located on a side of the glass wall which is a side inside the building.

26. An insulating glass wall according to claim 17, wherein all the sealing joints of each glazed panel are translucent.

27. An insulating glass wall according to claim 26, wherein the sealing joints are selected from a translucent mastic, a translucent adhesive, and a translucent organic tie sheet for tying to the glass, or a combination of at least two of these compounds.

28. An insulating glass wall according to claim 17, wherein at least one glass sheet of each glazed panel is coated with a layer of metal or metal oxide that makes it possible to improve thermal insulation and/or solar control performance of the glazed panel.

29. An insulating glass wall according to claim 17, wherein at least one glass sheet of at least one glazed panel is replaced by a laminated structure having a safety or acoustic function comprising at least one sheet made of translucent organic material adhesively bonded on both sides thereof to a glass sheet.

30. An insulating glass wall according to claim 29, wherein at least one glass sheet of at least one glazed panel is a tempered glass.

31. An insulating glass wall according to claim 17, wherein at least one glass sheet of at least one glazing is made of an enamelled, screenprinted, or matt glass.

32. A process for manufacturing an insulating glass wall for a building according to claim 17, wherein at least two glazed panels are hermetically assembled at one of their edges at least with aid of a translucent connection element having a structuring function.
